(19) United States
(12) Patent Application Publication
(10) Pub. No.: US 2026/0371366 A1
(43) Pub. Date: Nov. 19, 2026

(54) SIDELINK COMMUNICATIONS WITH MULTIPLE TRANSPORT BLOCKS

(71) Applicant: QUALCOMM Incorporated, San Diego, CA (US)

(72) Inventors: Shijun Wu, San Diego, CA (US); Kapil Gulati, Belle Mead, NJ (US); Tien Viet Nguyen, Bridgewater, NJ (US)

(21) Appl. No.: 19/208,189

(22) Filed: May 14, 2025

(51) Int. Cl. H04W 72/25; H04L 5/00

(52) U.S. Cl. CPC H04W 72/25; H04L 5/0053

(57) ABSTRACT

The present disclosure provides systems, apparatus, methods, and computer-readable media for supporting multiple transport blocks (TBs) in a single sidelink transmission. To enable such a single sidelink transmission with multiple TBs, a UE transmitting the single sidelink transmission may perform at least some transmit operations separately for different TBs (such as on a per-TB basis). After performing such transmit operations, the UE may map first bits of a first TB and second bits of a second TB to a set of resources used to transmit the sidelink transmission. Accordingly, data associated with multiple different TBs may be processed separately and then “consolidated” into the same sidelink transmission.

### TECHNICAL FIELD

Aspects of the present disclosure relate generally to wireless communications, and more particularly, to techniques for performing sidelink communications with multiple transport blocks (TBs).

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of network nodes (such as base stations), each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

One particular example of such a technical challenge in wireless communications is facilitating communication with multiple receive devices. In some wireless communication systems, wireless communications may be designed primarily for communication between single devices, such as from a single UE to a single network node (or vice versa). However, as the prevalence of wireless communication continues to increase, the need to facilitate other types of communications increases.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in an apparatus for wireless communication by a user equipment (UE). The apparatus includes a processing system including one or more processors and one or more memories coupled to the one or more processors. The processing system is configured to perform a multi-transport block (TB) resource mapping operation that maps, to a set of physical resource blocks (PRBs), first bits of a first TB associated with a first destination identifier (ID) and second bits of a second TB associated with a second destination ID. The processing system is further configured to transmit a single physical sidelink shared channel (PSSCH) transmission via the set of PRBs. The single PSSCH transmission includes the first TB addressed to the first destination ID and the second TB addressed to the second destination ID.

Another innovative aspect of the subject matter described in this disclosure can be implemented in a method of wireless communication by a UE. The method includes performing a multi-TB resource mapping operation that maps, to a set of PRBs, first bits of a first TB associated with a first destination ID and second bits of a second TB associated with a second destination ID. The method further includes transmitting a single PSSCH transmission via the set of PRBs. The single PSSCH transmission includes the first TB addressed to the first destination ID and the second TB addressed to the second destination ID.

Another innovative aspect of the subject matter described in this disclosure can be implemented in a non-transitory computer-readable medium storing instructions executable by one or more processors of a UE to initiate, perform, or control operations. The operations include performing a multi-TB resource mapping operation that maps, to a set of PRBs, first bits of a first TB associated with a first destination ID and second bits of a second TB associated with a second destination ID. The operations further include transmitting a single PSSCH transmission via the set of PRBs. The single PSSCH transmission includes the first TB addressed to the first destination ID and the second TB addressed to the second destination ID.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating an example wireless communication system that supports sidelink communications with multiple TBs according to one or more aspects.

FIG. 2 is a block diagram illustrating examples of a base station and a user equipment (UE) that support sidelink communications with multiple TBs according to one or more aspects.

FIG. 3 is a diagram illustrating examples of operations that support sidelink communications with multiple TBs according to one or more aspects.

FIG. 4 is a block diagram illustrating an example wireless communication system that supports sidelink communications with multiple TBs according to one or more aspects.

FIG. 5 is a block diagram illustrating example operations that support sidelink communications with multiple TBs according to one or more aspects.

FIG. 6 is a block diagram illustrating example virtual resource block (VRB) mapping schemes that support sidelink communications with multiple TBs according to one or more aspects.

FIG. 7 is a block diagram illustrating additional example VRB mapping schemes that support sidelink communications with multiple TBs according to one or more aspects.

FIG. 8 is a block diagram illustrating example sidelink control information (SCI) messaging that supports sidelink communications with multiple TBs according to one or more aspects.

FIG. 9 is a block diagram illustrating additional example SCI messaging that supports sidelink communications with multiple TBs according to one or more aspects.

FIG. 10 is a flow diagram illustrating an example process that supports sidelink communications with multiple TBs according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media for supporting multiple transport blocks (TBs) in a single sidelink transmission. To enable such a single sidelink transmission with multiple TBs, a UE transmitting the single sidelink transmission may perform at least some transmit operations separately for different TBs (such as on a per-TB basis) and may perform at least some other transmit operations on a joint basis (or on a multi-TB basis). For example, a first TB of a sidelink transmission may be associated with one or more of a first modulation and coding scheme (MCS), a first precoding, or a first codebook, and a second TB of the sidelink transmission may be associated with one or more of a second MCS different than the first MCS, a second precoding different than the first precoding, or a second codebook different than the first codebook. After performing such transmit operations, the UE may map first bits of the first TB and second bits of the second TB to a set of resources used to transmit the sidelink transmission. Accordingly, data associated with multiple different TBs may be processed separately and then “consolidated” into the same sidelink transmission.

Particular implementations of the subject matter described in this disclosure can be implemented to realize one or more of the following potential advantages. In some aspects, the disclosed techniques may improve performance by facilitating simultaneous communication with multiple devices. To illustrate, in one implementation, a smartphone UE may communicate with wearable devices (or other devices). By transmitting different respective TBs to the wearable devices via the same sidelink transmission, the smartphone UE may simultaneously communicate with the wearable devices, which may increase performance (such as by reducing latency) as compared to sequentially transmitting the TBs via multiple sidelink transmissions to the wearable devices. In another implementation, a vehicle UE may communicate with multiple other vehicles (or other devices). By transmitting different respective TBs to the other vehicles, the vehicle UE may simultaneously communicate with the vehicles, which may increase performance (such as by reducing latency) as compared to sequentially transmitting the TBs via multiple sidelink transmissions to the vehicles.

Another potential advantage of at least one implementation of the subject matter herein may include improved performance due to increased frequency diversity associated with a sidelink transmission. For example, by including multiple TBs in a single sidelink transmission, bandwidth of the sidelink transmission may be increased as compared to performing separate sidelink transmissions for each such TB. By increasing the bandwidth of the sidelink transmission, frequency diversity may be increased, which may improve the ability of a receive device to receive the sidelink transmission, thus decreasing latency, lost data, or the need to retransmit data.

An additional potential advantage of at least one implementation of the subject matter herein may include improved efficiency within a wireless communication system. For example, by supporting multiple TBs within a sidelink transmission, a UE may transmit the multiple TBs with fewer sidelink transmissions. Further, because each such sidelink transmission may be associated with at least some control information (or “overhead”), usage of wireless resources may be reduced by including multiple TBs within a single sidelink transmission. Accordingly, wireless resources may be freed for other operations by the UE, for other devices, or both.

Another potential advantage of at least one implementation of the subject matter herein may include reduced power consumption for a UE. For example, by supporting multiple TBs within a sidelink transmission, a UE may use fewer different transmit operations to transmit the multiple TBs. Further, in some scenarios, the UE may initiate a sleep or low-power mode sooner as a result of performing fewer sidelink transmissions. As a result, power consumption of the UE may be decreased due to a reduced quantity of transmissions, due to more rapid initiation of a sleep or low-power mode, or both. In some implementations, the decreased power consumption may improve battery life of a battery-powered UE.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ~1M nodes per km\hat{ }2), ultra-low complexity (such as ~10 s of bits per sec), ultra-low energy (such as ~10+years of battery life), and deep coverage with the capability to reach challenging locations; (2) including mission-critical control with strong security to safeguard sensitive personal, financial, or classified information, ultra-high reliability (such as ~99.9999% reliability), ultra-low latency (such as ~1 millisecond (ms)), and users with wide ranges of mobility or lack thereof; and (3) with enhanced mobile broadband including extreme high capacity (such as ~10 Tbps per km\hat{ }2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

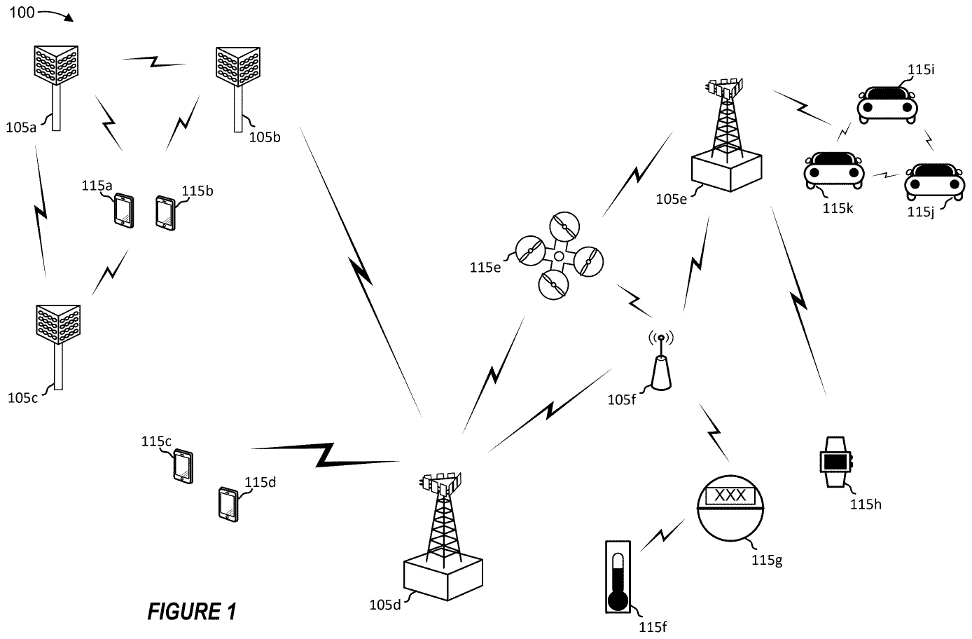

FIG. 1 is a block diagram illustrating an example wireless communication system that supports sidelink communications with multiple TBs according to one or more aspects. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

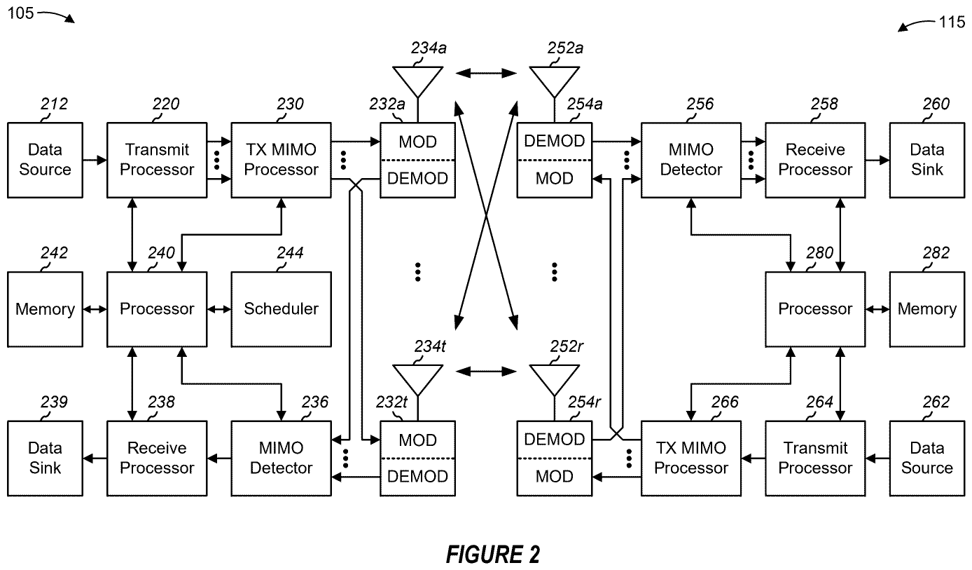

FIG. 2 is a block diagram illustrating examples of a base station 105 and a UE 115 that support sidelink communications with multiple TBs according to one or more aspects. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a processor 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the processor 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the processor 240.

The processors 240 and 280 may direct the operation at the base station 105 and the UE 115, respectively. The processor 240 or other processors and modules at the base station 105 or the processor 280 or other processors and modules at the UE 115 may perform or direct the execution of various processes for the techniques described herein, such as to initiate, perform, or control one or more operations illustrated in FIGS. 12 and 13, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

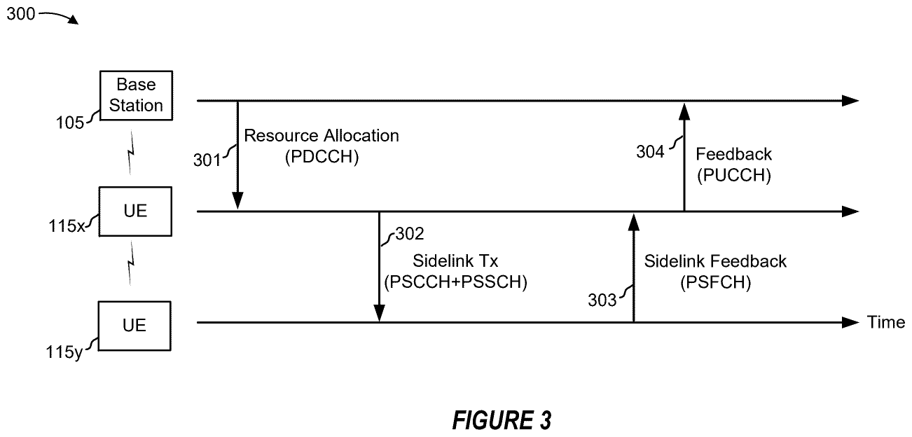

FIG. 3 is a diagram illustrating examples of operations 300 that support sidelink communications with multiple TBs according to one or more aspects. The operations 300 may be described with reference to a UE 115x (such as one of the UEs 115a-k of FIG. 1, or another UE), a UE 115y (such as another of the UEs 115a-k of FIG. 1, or another UE), and the base station 105. In some other examples, the operations 300 may be performed with respect to other UEs and other UE configurations.

The operations 300 may illustrate an example of a first mode of operation (Mode 1) in which resource allocation of Tx resources for sidelink communications is performed, at 301, by the base station 105. The first mode (Mode 1) may support dedicated grants (DGs) and configured grants (CGs) of type 1 and may further support CGs of type 2. A CG of type 1 may be activated via RRC signaling from the base station 105. A modulation and coding scheme (MCS) may be determined by a transmitting UE, such as the UE 115x, within parameters set by the base station 105 (such as parameters indicated by the DCI). In some other aspects of the disclosure, one or more other operations described herein may be performed using one or more other modes of operation, such as a second mode of operation (Mode 2).

At 302, the UE 115 x may perform a sidelink transmission (such as by transmitting sidelink control information (SCI), data, or a combination thereof) to the UE 115y via the sidelink. The sidelink may include a physical sidelink control channel (PSCCH), a physical sidelink shared channel (PSSCH), a physical sidelink feedback channel (PSFCH), one or more other channels, or a combination thereof. In some examples, the UE 115x may perform the sidelink transmission 302 using sidelink resources not included in the resource allocation indicated by the base station 105 (at 301). For example, in some cases, the UE 115x may “ignore” the resource allocation indicated by the base station 105, as described further below.

At 303, the UE 115y may transmit sidelink feedback to the UE 115x via the sidelink, such as via the PSFCH. In some examples, the feedback may include an acknowledgement (ACK) or a negative-acknowledgement (NACK). At 304, the UE 115x may forward the sidelink feedback to the base station 105, such as using a PUCCH. The base station 105 may perform one or more operations based on the sidelink feedback, such as resource allocation, as an illustrative example.

In some aspects, the sidelink transmission 302 may include a single PSSCH transmission including multiple transport blocks (TBs). Some illustrative examples of a single PSSCH transmission that includes multiple TBs are described further below.

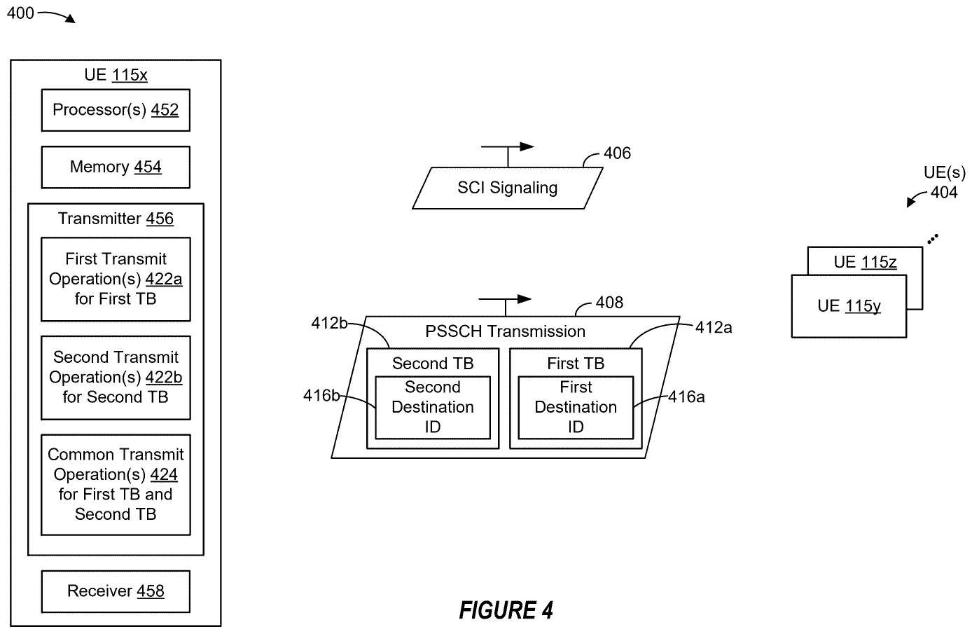

FIG. 4 is a block diagram illustrating an example wireless communication system 400 that supports sidelink communications with multiple TBs according to one or more aspects. The wireless communication system 400 may include the UE 115x and one or more UEs 404. In some examples, the one or more UEs 404 may include the UE 115y and a UE 115z. The wireless communication system 400 may also include one or more network nodes, such as one or more base stations 105 (not shown in FIG. 4). Depending on the example, a network node (or network entity) may be implemented as a base station, a network controller, an integrated access and backhauling (IAB) node, a distributed unit (DU), a central unit (CU), or a remote/radio unit (RU) (which may also be referred to as a remote radio unit (RRU)), as illustrative examples.

Each of the UEs 115x-z may include components including one or more processors (such as the processor 280), a memory (such as the memory 282), a transmitter, and a receiver. For example, the UE 115x may include one or more processors 452 (such as the processor 280), a memory 454 (such as the memory 282), a transmitter 456, and a receiver 458. The one or more processors 452 may be coupled to the memory 454, to the transmitter 456, and to the receiver 458. In some examples, the transmitter 456 and the receiver 458 may include one or more components described with reference to FIG. 2, such as one or more of the modulator/demodulators 254a-r, the MIMO detector 256, the receive processor 258, the transmit processor 264, or the TX MIMO processor 266. In some implementations, the transmitter 456 and the receiver 458 may be integrated in one or more transceivers of the UE 115x. In some examples, the one or more processors 452 are individually or collectively operable to perform one or more operations described herein.

The transmitter 456 may transmit reference signals, synchronization signals, control information, and data to one or more other devices, and the receiver 458 may receive reference signals, control information, and data from one or more other devices. For example, in some implementations, the transmitter 456 may transmit signaling, control information, and data to the one or more UEs 404, and the receiver 458 may receive signaling, control information, and data from the one or more UEs 404.

The wireless communication system 400 may use wireless communication channels, which may be specified by one or more wireless communication protocols, such as a 5G NR wireless communication protocol. To illustrate, a network node may communicate with the UE 115x using one or more downlink wireless communication channels (such as via one or more of a PDSCH or a PDCCH). The UE 115x may communicate with the network node using one or more uplink wireless communication channels (such as via one or more of a PUSCH or a PUCCH). The UE 115x may communicate with the one or more UEs 404, such as via a sidelink wireless communication channel. Examples of sidelink wireless communication channels include a PSSCH, a PSCCH, and a PSFCH, such as described with reference to FIG. 3.

During operation, the UEs 115x-z may perform sidelink communication operations. For example, the UE 115x may perform a PSSCH transmission 408. The PSSCH transmission may include multiple transport blocks (TBs), such as a first TB 412a and a second TB 412b. Although the example of FIG. 4 may illustrate that the PSSCH transmission may include two TBs, in other examples, the PSSCH transmission 408 may include a different quantity of TBs, such as three or more TBs. In some examples, the UEs 115x-z may support up to N TBs in the PSSCH transmission 408, where N is a positive integer indicating a maximum supported quantity (or limit) for TBs within a PSSCH transmission. In some examples, N may be specified by a wireless communication protocol or may be configured by a network node, such as the base station 105.

In some examples, one or more TBs of the PSSCH transmission 408 may indicate or may be associated with a destination identifier (ID). For example, the first TB 412a may be associated with a first destination ID 416a, and the second TB 412b may be associated with a second destination ID 416b. The first destination ID 416a may indicate a first receive destination for the first TB 412a, and the second destination ID 416b may indicate a second receive destination for the second TB 412b. In some examples, the first destination ID 416a may be different than the second destination ID 416b. In some other examples, the first destination ID 416a may be the same as the second destination ID 416b.

To further illustrate, in some examples, the first destination ID 416a may be associated with a second UE (such one of the UE 115y or the UE 115z), and the second destination ID 416b may be associated with a third UE (such as the other of the UE 115y or the UE 115z) different than the second UE. In such examples, the second UE and the third UE may both receive the PSSCH transmission 408. The second UE may decode the first TB 412a in accordance with the first destination ID 416a and may ignore, discard, or avoid decoding the second TB 412b in accordance with the second destination ID 416b. The third UE may decode the second TB 412b in accordance with the second destination ID 416b and may ignore, discard, or avoid decoding the first TB 412a in accordance with the first destination ID 416a.

In some other examples, both the first destination ID 416a and the second destination ID 416b may be associated with a same second UE, such as one of the UEs 115y-z. To illustrate, the first destination ID 416a may be associated with a first application executing in the second UE, and the second destination ID 416b may be associated with a second application executing in the second UE, where second application is different than the first application. In another example, the destination IDs 416a-b may correspond to different respective virtual devices that are executed by or associated with a same second UE.

To further illustrate, in some examples, the first destination ID 416a may include at least a portion of a first layer-2 destination ID, and the second destination ID 416b may include at least a portion of a second layer-2 destination ID. In some examples, such a layer-2 ID may specify a physical device as a destination of a TB. The wireless communication system 400 may utilize such layer-2 destination IDs for routing, such as to ensure delivery of a TB to a physical device. Such layer-2 destination IDs may comply with a wireless communication protocol, which may specify, for example, a bitlength and a format of the layer-2 destination IDs. The format may indicate, for example, different fields of each layer-2 destination ID, such as one or more of a network identifier field, a node identifier field, a service identifier field, or another field. In some implementations, the first destination ID 416a may include a subset of the first layer-2 destination ID, and the second destination ID 416b may include a subset of the second layer-2 destination ID. For example, the first destination ID 416a may include a particular quantity of least significant bits (LSBs), or a particular field, of the first layer-2 destination ID, and the second destination ID 416b may the particular quantity of LSBs of, or the particular field, the second layer-2 destination ID. As an example, a layer-2 destination ID may be associated with a bitlength of twenty-four bits, and a destination ID may be generated from the layer-2 destination ID by selecting sixteen of the twenty-four bits. Other examples are also within the scope of the disclosure.

In some further examples, the first destination ID 416a and the second destination ID 416b may be another type of ID, such as, for example, application layer IDs. In such examples, the first destination ID 416a may include at least a portion of a first application layer ID, and the second destination ID 416b may include at least a portion of a second application layer ID. Such an application layer ID may specify an application as a destination of a TB. Further, such applications may be associated with different respective UEs or with a common UE. To illustrate, in one example, the first destination ID 416a may be associated with a first application executed by the UE 115y, and the second destination ID 416b may be associated with a second application. In some examples, the second application may be executed by the UE 115y. In some other examples, the second application may be executed by the UE 115z.

The PSSCH transmission 408 may also be referred to as a single PSSCH transmission or as a single sidelink transmission. In some implementations, the UE 115x may perform the PSSCH transmission 408 using one or more of a single time slot, a single transmission opportunity, or a single sidelink transmission occasion. In such examples, the TBs 412a-b may be associated with one or more of a common time slot, a common transmission opportunity, or a common sidelink transmission occasion.

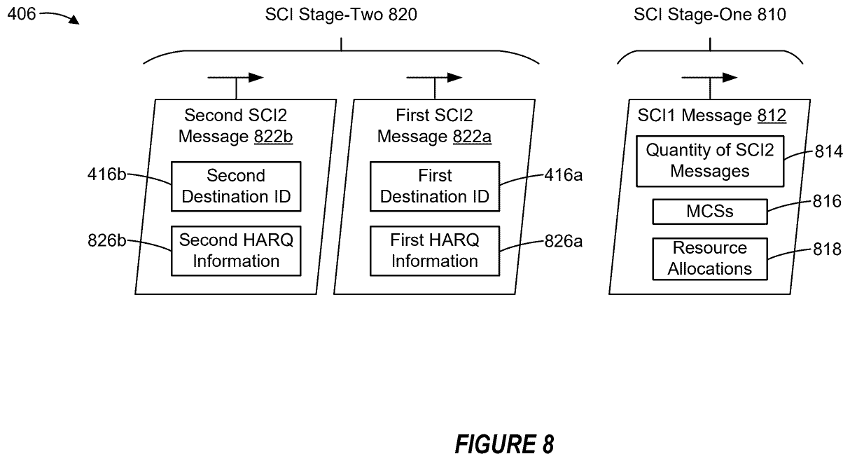

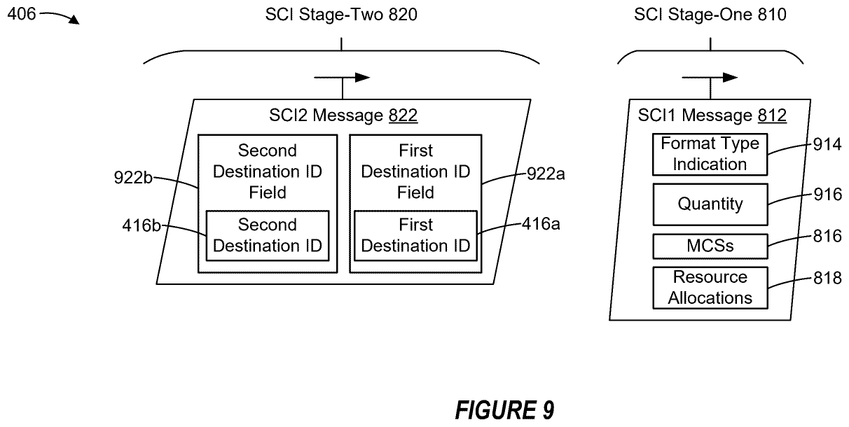

In some examples, the UE 115x may transmit sidelink control information (SCI) messaging 406 associated with the PSSCH transmission 408. In some examples, the SCI messaging 406 may include information associated with the PSSCH transmission 408, such as information indicating resources associated with the PSSCH transmission 408. One or more UEs (such as the UEs 115y-z) may receive the SCI messaging 406. Further, the UEs 115y-z may receive the PSSCH transmission 408 in accordance with the SCI messaging 406, such as by using resources indicated by the SCI messaging 406 to receive the PSSCH transmission 408. In some examples, the UE 115x may transmit the SCI messaging 406 in accordance with a single-stage SCI format or a multi-stage SCI format. Some illustrative examples that may be associated with a multi-stage SCI format are described further with reference to FIGS. 8 and 9.

In some examples, one or both of the SCI messaging 406 or the PSSCH transmission 408 may be included in the sidelink transmission 302 of FIG. 3. For example, the UE 115x may transmit the SCI messaging 406 via the PSSCH described with reference to the sidelink transmission 302 of FIG. 3. Alternatively, or in addition, the UE 115x may perform the PSSCH transmission 408 via the PSSCH described with reference to the sidelink transmission 302 of FIG. 3. Further, after performing the PSSCH transmission 408, the UE 115x may receive sidelink feedback from one or more UEs receiving the PSSCH transmission 408, such as from one or more of the UEs 115y-z. The sidelink feedback may correspond to the sidelink feedback 303 of FIG. 3.

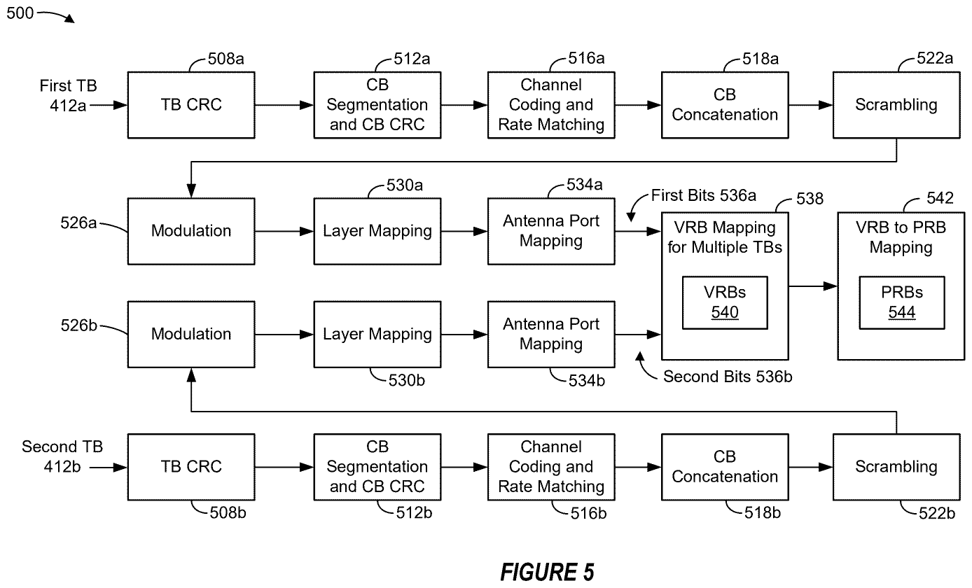

In some aspects of the disclosure, the UE 115x may perform at least some transmit operations associated with the PSSCH transmission 408 on a per-TB basis and may perform at least some other operations associated with the PSSCH transmission 408 on a multi-TB (or “global”) basis. To illustrate, the UE 115x may perform one or more first transmit operations 422a for the first TB 412a and may perform one or more second transmit operations 422b for the second TB 412b. The transmit operations 422a-b may include separately processing bits of the TBs 412a-b. To illustrate, in some examples, such separate processing may include one or more of cyclic redundancy check (CRC) generation, code block segmentation, channel coding, rate matching, CB concatenation, scrambling, modulation, layer mapping, or antenna port mapping, which may be performed separately for the TBs 412a-b. In some such examples, the first TB 412a may be associated with one or more of a first modulation and coding scheme (MCS), a first precoding, or a first codebook, and the second TB 412b may be associated with one or more of a second MCS different than the first MCS, a second precoding different than the first precoding, or a second codebook different than the first codebook. Further, the UE 115x may also perform one or more common transmit operations 424 for both the TBs 412a-b. For example, the UE 115x may map bits associated with the TBs 412a-b to a set of resources associated with the PSSCH transmission 408. Some illustrative examples of such operations are described further with reference to FIG. 5.

FIG. 5 is a block diagram illustrating example operations 500 that support sidelink communications with multiple TBs according to one or more aspects. For example, the UE 115x may perform the operations 500 to transmit the TBs 412a-b via the PSSCH transmission 408.

The operations 500 associated with the first TB 412a may include performing a TB cyclic redundancy check (CRC) associated with the first TB 412a, at 508a. The operations 500 may further include performing code block (CB) segmentation and a CB CRC, at 512a, performing CB concatenation, at 518a, and performing scrambling, at 522a. In addition, the operations 500 may further include performing modulation, at 526a, performing layer mapping, at 530a, and performing antenna port mapping, at 534a. Performing the antenna port mapping may generate first bits 536a that are associated with the first TB 412a.

The operations 500 associated with the second TB 412b may include performing a TB CRC associated with the second TB 412b, at 508b. The operations 500 may further include performing CB segmentation and a CB CRC check, at 512b, performing CB concatenation, at 518b, and performing scrambling, at 522b. In addition, the operations 500 may further include performing modulation, at 526b, performing layer mapping, at 530b, and performing antenna port mapping, at 534b. Performing the antenna port mapping may generate second bits 536b that are associated with the second TB 412b.

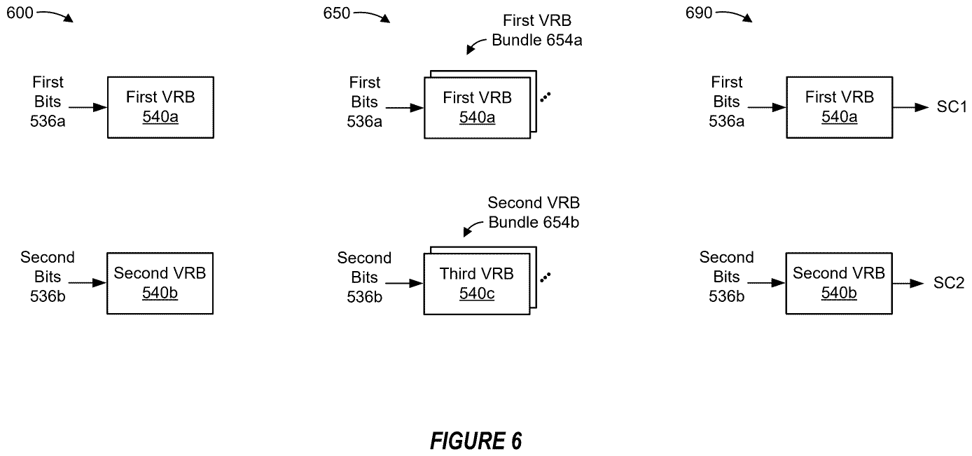

After performing the antenna port mapping (at 534a-b), the operations 500 may further include performing virtual resource block (VRB) mapping for multiple TBs, at 538. Performing the VRB mapping may include simultaneously mapping bits from multiple TBs to one or more VRBs. For example, the first bits 536a associated with the first TB 412a and the second bits 536b associated with the second TB 412b may be mapped a set of VRBs 540. Some illustrative examples of VRB mapping are described further with reference to FIG. 6.

The operations 500 may also include performing VRB to physical resource block (PRB) mapping, at 542. For example, the set of VRBs 540 may be mapped to a set of PRBs 544. In some examples, the UE 115x may perform the PSSCH transmission 408 using the set of PRBs 544. For example, the set of PRBs 544 may specify time resources and frequency resources used by the UE 115x to perform the PSSCH transmission 408.

In some examples, one or more of the operations 508a, 512a, 516a, 518a, 522a, 526a, 530a, and 534a may be included in the one or more first operations 422a of FIG. 4, and one or more of the operations 508b, 512b, 516b, 518b, 522b, 526b, 530b, and 534b may be included in the one or more second operations 422b of FIG. 4. In some examples, one or more of the operations 538 and 542 may be included in the one or more common transmit operations 424 of FIG. 4.

FIG. 6 is a block diagram illustrating example VRB mapping schemes that support sidelink communications with multiple TBs according to one or more aspects. In the example of FIG. 6, the VRB mapping schemes may include a per-VRB basis 600, a per-VRB-bundle basis 650, and a per-subchannel basis 690.

In accordance with the per-VRB basis 600, bits of different TBs may be separately partitioned to different respective VRBs. In some such examples, each VRB may include bits of only one TB (and no VRB may include bits of multiple TBs). To illustrate, the first bits 536a and the second bits 536b may be separately partitioned to one or more first VRBs (such as a first VRB 540a and to one or more second VRBs (such as a second VRB 540b), respectively. In some such examples, the first VRB 540a may include the first bits 536a (and may not include any of the second bits 536b), and the second VRB 540b may include the second bits 536b (and may not include any of the first bits 536a).

In accordance with the per-VRB bundle basis 650, bits of different TBs may be separately partitioned to different respective VRB bundles. In some such examples, each VRB bundle may include bits of only one TB (and no VRB bundle may include bits of multiple TBs). To illustrate, the first bits 536a and the second bits 536b may be separately partitioned to one or more first VRB bundles (such as a first VRB bundle 654a) and to one or more second VRB bundles (such as a second VRB bundle 654b), respectively. In some such examples, the first VRB bundle 654a may include the first bits 536a (and may not include any of the second bits 536b), and the second VRB bundle 654b may include the second bits 536b (and may not include any of the first bits 536a).

In accordance with the per-subchannel basis 690, bits of different TBs may be separately partitioned to different respective VRBs that are associated with different respective subchannels. In some such examples, each subchannel may be associated with bits of only one TB (and no subchannel may be associated with bits of multiple TBs). To illustrate, the first bits 536a and the second bits 536b may be separately partitioned to one or more first VRBs (such as a first VRB 540a) and to one or more second VRBs (such as a second VRB 540b), respectively. The one or more first VRBs may be associated with a first subchannel (SC1), and the one or more second VRBs may be associated with a second subchannel (SC2).

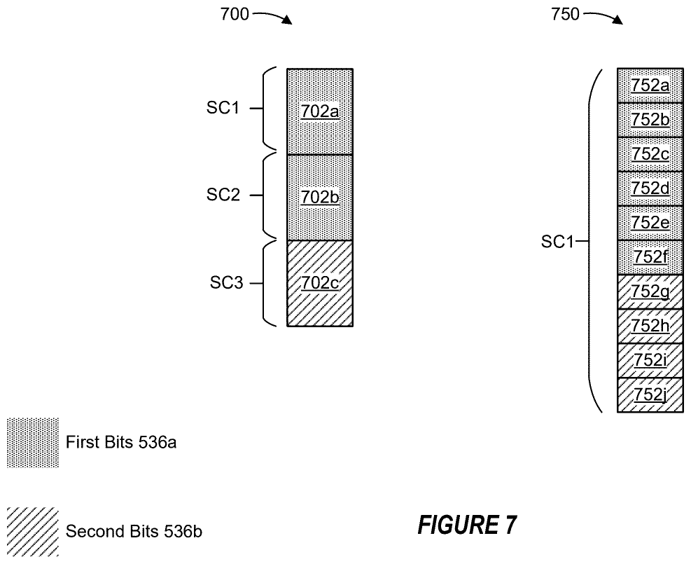

FIG. 7 is a block diagram illustrating additional example VRB mapping schemes that support sidelink communications with multiple TBs according to one or more aspects. In the example of FIG. 7, the VRB mapping schemes may include a VRB mapping scheme 700 and a VRB mapping scheme 750.

In the VRB mapping scheme 700, bits of different TBs may be allocated to different respective subchannels. Further, in the VRB mapping scheme 700, a subchannel may be referred to as a “resource unit” for TB mapping (where each subchannel is associated with no more than one TB). To illustrate, the first bits 536a associated with the first TB 412a may be allocated to a first subchannel (SC1) 702a and a second subchannel (SC2) 702b, and the second bits 536b associated with the second TB 412b may be allocated to a third subchannel (SC3) 702c. In some examples, precoding may be performed (or a codebook may be used) on a per-subchannel basis. In some examples, the VRB mapping scheme 700 may correspond to an implementation of the per-subchannel basis 690 of FIG. 6.

In the VRB mapping scheme 750, bits of different TBs may be allocated to different respective resource blocks (RBs) (or VRBs). Further, in the VRB mapping scheme 750, an RB (or VRB) may be referred to as a “resource unit” for TB mapping (where each RB, or VRB, is associated with no more than one TB). To illustrate, the first bits 536a associated with the first TB 412a may be allocated to RBs 752a-f, and the second bits 536b associated with the second TB 412b may be allocated to RBs 752g-j. Further, the RBs 752a-j may be associated with a common subchannel (SC1). In some examples, if multiple TBs are transmitted to multiple respective UEs, open loop precoding may be used to reduce transmit complexity, receive complexity, or both. In some examples, the VRB mapping scheme 750 may correspond to an implementation of the per-VRB basis 600 of FIG. 6.

In the examples illustrated in FIG. 7, the VRB mapping scheme 700 and the VRB mapping scheme 750 may each correspond to non-interleaved VRB mapping schemes. Other examples are also within the scope of the disclosure. For example, in some implementations, the first bits 536a may be allocated to the first subchannel 702a and to the third subchannel 702c, and the second bits 536b may be allocated to the second subchannel 702b. Such examples may be referred to as subchannel interleaving. As another example, the first bits 536a may be allocated to one or more of the RBs 752g-j, and the second bits 536b may be allocated to one or more of the RBs 752a-f. Such examples may be referred to as RB interleaving, VRB interleaving, or PRB interleaving, which may increase frequency diversity associated with a TB. For an interleaved VRB-to-PRB mapping, a VRB bundle size may be less than or equal to a subchannel size.

FIG. 8 is a block diagram illustrating example SCI messaging 406 that supports sidelink communications with multiple TBs according to one or more aspects. In the example of FIG. 8, the SCI messaging 406 may be associated with a multi-stage format. For example, the multi-stage format may include SCI stage-one 810 and SCI stage-two 820 that follows SCI stage-one 810. During SCI stage-one 810, the UE 115x may transmit one or more stage-one SCI (SCI1) messages, such as an SCI1 message 812. During SCI stage-two 820, the UE 115x may transmit one or more stage-two SCI (SCI2) messages, such as a first SCI2 message 822a and a second SCI2 message 822b.

In some examples, the SCI1 message 812 may indicate a quantity 814 of SCI2 messages that are to follow the SCI1 message 812. To illustrate, the quantity 814 may correspond to a quantity of SCI2 messages that are associated with SCI stage-two 820. Further, in some examples, the quantity 814 of SCI2 messages may be equal to the quantity of TBs included in the PSSCH transmission 408. To illustrate, in the example of FIG. 8, the quantity 814 of SCI2 messages (and the quantity of TBs included in the PSSCH transmission 408) may correspond to two. In some other examples, the quantity 814 may correspond to another value. To illustrate, in an example in which the PSSCH transmission 408 includes three TBs, SCI stage-two 820 may include three SCI2 messages, and the quantity 814 may correspond to three. Other examples are also within the scope of the disclosure.

Alternatively, or in addition, the SCI1 message 812 may indicate modulation and coding schemes (MCSs) 816 associated with one or more TBs of the PSSCH transmission 408. To illustrate, the MCSs 816 may include a first MCS used by the UE 115x to modulate and encode the first TB 412a and may further include a second MCS used by the UE 115x to modulate and encode the second TB 412b. In some examples, the UE 115x may use the first MCS in connection with one or more of the operations 508a, 512a, 516a, 518a, 522a, 526a, 530a, and 534a of FIG. 5. As an example, the UE 115x may perform modulation, at 526a, in accordance with the first MCS. Further, the UE 115x may use the second MCS in connection with one or more of the operations 508b, 512b, 516b, 518b, 522b, 526b, 530b, and 534b of FIG. 5, such as by performing modulation, at 526b, in accordance with the second MCS. In some examples, the first MCS may be different than the second MCS (such as, for example, to facilitate different data sizes of the TBs 412a-b). In some other examples, the first MCS may be the same as the second MCS.

Alternatively, or in addition, the SCI1 message 812 may indicate resource allocations 818 for TBs of the PSSCH transmission 408. For example, the resource allocations 818 may include a first resource allocation associated with the first TB 412a and may further include a second resource allocation associated with the second TB 412b. In some examples, the first resource allocation may include a first set of time and frequency resources used to transmit the first TB 412a, and the second resource allocation may include a second set of time and frequency resources used to transmit the second TB 412b. In some examples, a resource allocation may include or may be referred to as a resource assignment or as a bandwidth assignment.

In some examples, a receive UE that receives the SCI1 message 812 may monitor for one or more SCI2 messages of SCI stage-two 820 in accordance with at least some information indicated by the SCI1 message 812. For example, by indicating the quantity 814 of SCI2 messages that are to follow the SCI1 message 812, the UEs 115y-z may “expect” a particular quantity of SCI2 messages, such as two SCI2 messages. In some examples, after receiving the quantity 814 of SCI2 messages following the SCI1 message, the UEs 115y-z may enter an inactive or sleep mode of operation.

In the example of FIG. 8, the first SCI2 message 822a may indicate one or more of the first destination ID 416a associated with the first TB 412a or first hybrid automatic repeat request (HARQ) information 826a associated with the first TB 412a. In some examples, the first HARQ information 826a may include one or more of a first new data indicator (NDI) associated with the first TB 412a, a first HARQ process number associated with the first TB 412a, or a first redundancy version associated with the first TB 412a. Further, the second SCI2 message 822b may indicate one or more of the second destination ID 416b associated with the second TB 412b or second HARQ information 826b associated with the second TB 412b. In some examples, the second HARQ information 826b may include one or more of a second NDI associated with the second TB 412b, a second HARQ process number associated with the second TB 412b, or a second redundancy version associated with the second TB 412b.

FIG. 9 is a block diagram illustrating additional example SCI messaging 406 that supports sidelink communications with multiple TBs according to one or more aspects. In the example of FIG. 9, the SCI messaging 406 may be associated with a multi-stage format. For example, the multi-stage format may include SCI stage-one 810 and SCI stage-two 820 that follows SCI stage-one 810. During SCI stage-one 810, the UE 115x may transmit one or more stage-one SCI (SCI1) messages, such as the SCI1 message 812. During the SCI stage-two 820, the UE 115x may transmit a single SCI2 message 822.

In the example of FIG. 9, the SCI2 message 822 may indicate scheduling of multiple TBs of the PSSCH transmission 408. For example, the SCI2 message 822 may indicate scheduling of the first TB 412a and the second TB 412b. Accordingly, FIG. 8 may illustrate an example in which different TBs of a PSSCH transmission may be associated with different respective SCI2 messages, and FIG. 9 may illustrate an example in which different TBs of a PSSCH transmission may be associated with a common SCI2 message. Some illustrative example techniques for enabling a common SCI2 message for multiple TBs of a PSSCH transmission are described further below.

In some examples, the SCI2 message 822 of FIG. 9 may have a particular format type that is associated with scheduling of multiple TBs. To illustrate, the UE 115x may select the particular format type of the SCI2 message 822 from among a set of format types including a first format type associated with single-TB PSSCH transmissions and at least a second format type associated with multi-TB PSSCH transmissions. The UE 115x may select the first format type for a single-TB PSSCH transmission and may select the second format type a multi-TB PSSCH transmission, such as the PSSCH transmission 408. In some implementations, the set of format types may be specified by a wireless communication standard or may be configured by a network node, such as the base station 105.

Devices receiving an SCI2 message associated with a PSSCH transmission may detect, based on the particular format type, whether the PSSCH transmission is to include a single TB or multiple TBs. For example, if the UEs 115y-z receive the SCI2 message 822, the UEs 115y-z may detect, based on the particular format type of the SCI2 message 822, that the PSSCH transmission 408 is to include multiple TBs (including the first TB 412a and the second TB 412b). Further, in some implementations, the SCI1 message 812 may indicate the particular format type, such as by including a format type indication 914. The format type indication 914 may specify the particular format type of the SCI2 message 822. Upon determining a format type for a PSSCH transmission, a UE may receive the PSSCH transmission using one or more receive operations that are in accordance with the format type. For example, the receive operations may include different physical layer (PHY) processing operations depending on whether the payload of a PSSCH transmission includes one TB or multiple TBs (such as in the case of the PSSCH transmission 408 of FIG. 4).

To further illustrate, in some examples, the set of format types may include one format type for multi-TB PSSCH transmissions, or the set of format types may include multiple different format types for multi-TB PSSCH transmissions. As an example, in one implementation, one format type may be used for multi-TB PSSCH transmissions irrespective of the quantity of TBs in each such multi-TB PSSCH transmissions. In another implementation, each different quantity of TBs of a multi-TB PSSCH transmission may be associated with a different respective format type. In such examples, an SCI2 message associated with a two-TB PSSCH transmission may be associated with one format type, and an SCI2 message associated with a three-TB PSSCH transmission may be associated with another format type. In some examples, N different format types may be supported for SCI2 messages, where N is a positive integer indicating a maximum supported quantity (or limit) for TBs within a PSSCH transmission.

In some other examples, SCI2 messages associated with single-TB PSSCH transmissions and SCI2 messages associated with multi-TB PSSCH transmissions may be associated with a common format type. To illustrate, in such examples, the SCI2 message 822 of FIG. 9 may include information identifying the TBs 412a-b of the PSSCH transmission 408. For example, such information may include the first destination ID 416a and the second destination ID 416b. To illustrate, the SCI1 message 812 may indicate a quantity 916 of TBs of the PSSCH transmission 408 (such as the quantity 814), and the SCI2 message 822 may include the quantity 916 of destination IDs (or destination ID fields, which may include or convey respective destination IDs). For example, the SCI1 message 812 may indicate two TBs, and the SCI2 message 822 may have two destination ID fields, such as a first destination ID field 922a associated with the first destination ID 416a and a second destination ID field 922b associated with the second destination ID 416b. In such examples, the quantity 916 may correspond to two. Other examples are also within the scope of the disclosure, such as examples using three or more TBs. In some such examples, the quantity 916 may correspond to three or another quantity.

In some further aspects of the disclosure, the UE 115x may indicate resource allocations for TBs of a PSSCH transmission using physical layer (PHY) control messaging. Different examples of such PHY control signaling are described further below. In some examples, the PHY control signaling may be performed using one or more features described with reference to the SCI messaging 406 of FIG. 8, the SCI messaging 406 of FIG. 9, or a combination thereof.

In a first example of the PHY control messaging, the PHY control messaging may include the SCI1 message 812, which may indicate the a resource allocation associated with at least some of the TBs 412a-b. For example, the PHY control messaging may include the resource allocations 818 associated with the TBs 412a-b. One or more UEs receiving the SCI1 message 812 (such as the UEs 115y-z) may receive the TBs 412a-bin accordance with the resource allocations 818.

To further illustrate, in the first example of the PHY control messaging, the TBs 412a-b may be mapped to different respective subchannels. The resource allocations 818 may include a frequency domain resource assignment (FDRA) indicating at least an assigned bandwidth of the PSSCH transmission 408. In some examples, the assigned bandwidth may be expressed as a quantity of subchannels associated with the PSSCH transmission 408. Further, in some examples, the FDRA may implicitly indicate a resource allocation for at least one TB of the PSSCH transmission 408. For example, in a two-TB example of the PSSCH transmission 408 (where the PSSCH transmission 408 includes the two TBs 412a-b), the FDRA may indicate a portion of the assigned bandwidth that is associated with the first TB 412a. In such examples, a remainder of the assigned bandwidth (that is, the assigned bandwidth minus the portion associated with the first TB 412a) may be associated with the second TB 412b. In some examples, the TBs 412a-b may be mapped to the subchannels in order of index values. For example, the first TB 412a may be associated with an index value of one, and the second TB 412b may be associated with an index value of two. In a mapping scheme in which lower-valued TBs are mapped to lower-valued subchannels prior to mapping higher-valued TBs, the first TB 412a may be mapped to one or more of the subchannels prior to mapping the second TB 412b to one or more others of the subchannels. Further, in some examples, a single-TB PSSCH transmission may be indicated by setting the resource assignment of a TB to be equal to the resource assignment for the PSSCH transmission.

In a second example of the PHY control messaging, the SCI1 message 812 may indicate a resource allocation associated with the PSSCH transmission 408 (such as a “total” resource allocation for the PSSCH transmission 408), and one or more SCI2 messages (such as the SCI2 messages 822a-b of FIG. 8 or the SCI2 message 822 of FIG. 9) may indicate per-TB resource allocations for the TBs 412a-b. Such per-TB resource allocations may correspond to the resource allocations 818 and may include a first resource allocation associated with the first TB 412a and a second resource allocation associated with the second TB 412b. A UE receiving the SCI messaging 406 (such as the UEs 115y-z) may decode the SCI1 message 812 and may use decoded information of the SCI1 message 812 to decode the one or more SCI2 messages. In the case of multiple SCI2 messages (such as the SCI2 messages 822a-b of FIG. 8), the multiple SCI2 messages may be resource-mapped sequentially, such as where the first SCI2 message 822a is resource-mapped prior to resource-mapping of the second SCI2 message 822b, and where resource-mapping of the second SCI2 message 822b may begin with a resource that follows a last resource mapped to the first SCI2 message 822a.

In the second example of the PHY control messaging, the one or more SCI2 messages may indicate frequency resources for each TB of the PSSCH transmission 408. For example, the one or more SCI2 messages may indicate, for each TB of the PSSCH transmission 408, a quantity of subchannels assigned to the TB. As an example, the first SCI2 message 822a of FIG. 8 may indicate a first quantity of subchannels assigned to the first TB 412a, and the second SCI2 message 822b of FIG. 8 may indicate a second quantity of subchannels assigned to the second TB 412b. As another example, the SCI2 message 822 of FIG. 9 may indicate both the first quantity of subchannels and the second quantity of subchannels. Further, at least one such quantity of subchannels may be indicated implicitly. For example, if the SCI1 message 812 indicates a total quantity of subchannels for TBs of the PSSCH transmission 408, and if the one or more SCI2 messages indicate the first quantity of subchannels associated with the first TB 412a, a receive UE may determine (or “infer”) the second quantity of subchannels associated with the second TB 412b as the difference between the total quantity of subchannels and the first quantity of subchannels.

In some additional aspects of the disclosure, resource mapping for the SCI messaging 406 may be performed using one or more techniques. For example, the resource mapping may be performed in connection with a single SCI2 message (such as the SCI2 message 822 of FIG. 9) or in connection with multiple SCI2 messages (such as the SCI2 messages 822a-b of FIG. 8). In an example scheme that uses a single SCI2 message, resources used to transmit the SCI1 message 812 may include predefined resources selected from a sidelink resource pool, and the SCI1 message 812 may identify resources used to transmit the SCI2 message 822.

In some examples, resource mapping associated with the SCI2 messages 822a-b may be performed differently than, or independently of, resource mapping associated with the TBs 412a-b. To illustrate, in one example scheme that uses multiple SCI2 messages (such as the SCI2 messages 822a-b), the multiple SCI2 messages may be mapped sequentially using a set of available resources. For example, the first SCI2 message 822a may be associated with a first subset of resources of a set of resources, and the second SCI2 message 822b may be associated with a second subset of resources of the set of resources. In some such examples, the first subset of resources may start from an initial PSSCH DMRS symbol within a resource assignment associated with the PSSCH transmission 408, and the second subset of resources may begin after the final resource of the first subset. For example, modulation symbols of the first SCI2 message 822a may be mapped to a first orthogonal frequency division multiplexing (OFDM) symbol of the set of resources, and then to second OFDM symbol of the set, up to a kth OFDM symbol of the set such that all modulation symbols of the first SCI2 message 822a are mapped to OFDM symbols (where k indicates a positive integer). After mapping the modulation symbols of the first SCI2 message 822a, modulation symbols of the second SCI2 message 822b may be mapped beginning with a (k+1)th OFDM symbol of the set, and then to a (k+2)th OFDM symbol of the set, up to an mth OFDM symbol, until all modulation symbols of the second SCI2 message 822b are mapped to OFDM symbols of the set of resources (where m indicates a positive integer greater than k). In such examples, the first subset may include the first OFDM symbol through the kth OFDM symbol, and the second subset may include the (k+1)th OFDM symbol through the mth OFDM symbol.

In some other examples, resource mapping associated with the SCI2 messages 822a-b may be performed using the same resource mapping associated with the TBs 412a-b. To illustrate, in another example scheme that uses the multiple SCI2 messages, the multiple SCI2 messages may be mapped to subchannels associated with respective TBs corresponding to the multiple SCI2 messages. In such examples, the first SCI2 message 822a may be transmitted via a first subchannel that is also used to transmit the first TB 412a, and the second SCI2 message 822b may be transmitted via a second subchannel that is used to transmit the second TB 412b. In some such examples, a TB and an SCI2 message associated with the TB may be associated with a common resource mapping, such as where the first TB 412a and the first SCI2 message 822a are associated with a first resource mapping, and where the second TB 412b and the second SCI2 message 822b are associated with a second resource mapping.

Although some examples may be described with reference to transmit-side operations for illustration, it is noted that a receive UE may perform complementary operations to receive one or more of the SCI messaging 406 or the PSSCH transmission 408. For example, the UEs 115y-z may perform receive operations corresponding to an inverse of any of the transmit operations 422a-b, the common transmit operations 424, or the operations 500 of FIG. 5.

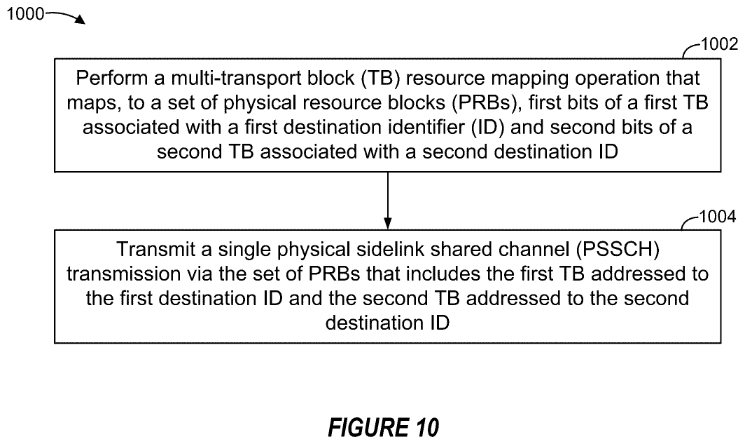

FIG. 10 is a flow diagram illustrating an example process 1000 that supports sidelink communications with multiple TBs according to one or more aspects. In some examples, the process 1000 may be performed by a UE, such as by the UE 115x or another UE.

The process 1000 includes performing a multi-transport block (TB) resource mapping operation that maps, to a set of physical resource blocks (PRBs), first bits of a first TB associated with a first destination identifier (ID) and second bits of a second TB associated with a second destination ID, at 1002. For example, the UE 115x may perform the VRB to PRB mapping illustrated at 542 of FIG. 5 to map, to the set of PRBs 544, first bits of the first TB 412a associated with the first destination ID 416a and second bits of the second TB 412b associated with the second destination ID 416b.

The process 1000 further includes transmitting a single physical sidelink shared channel (PSSCH) transmission via the set of PRBs that includes the first TB addressed to the first destination ID and the second TB addressed to the second destination ID, at 1004. For example, the UE 115x may transmit the PSSCH transmission 408 via the set of PRBs 544, and the PSSCH transmission 408 may include the first TB 412a addressed to the first destination ID 416a and may further include the second TB 412b addressed to the second destination ID 416b.

In a first aspect, an apparatus for wireless communication by a user equipment (UE) includes a processing system including one or more processors and one or more memories coupled to the one or more processors. The processing system is configured to perform a multi-transport block (TB) resource mapping operation that maps, to a set of physical resource blocks (PRBs), first bits of a first TB associated with a first destination identifier (ID) and second bits of a second TB associated with a second destination ID. The processing system is further configured to transmit a single physical sidelink shared channel (PSSCH) transmission via the set of PRBs. The single PSSCH transmission includes the first TB addressed to the first destination ID and the second TB addressed to the second destination ID.

In a second aspect, in combination with the first aspect, the processing system is further configured to transmit, in accordance with a two-stage SCI format, a stage-one sidelink control information (SCI1) message associated with the single PSSCH transmission. The SCI1 message indicates one or more of a quantity of stage-two sidelink control information (SCI2) messages associated with the single PSSCH transmission that are to follow the SCI1 message, respective modulation and coding schemes (MCSs) associated with the first TB and the second TB, or respective resource allocations for the first TB and the second TB.

In a third aspect, in combination with one or more of the first aspect or the second aspect, the processing system is further configured to transmit, in accordance with the two-stage SCI format, a first SCI2 message of the SCI2 messages. The first SCI2 message indicates one or more of the first destination ID or first hybrid automatic repeat request (HARQ) information associated with the first TB. The processing system is further configured to transmit, in accordance with the two-stage SCI format, a second SCI2 message of the SCI2 messages. The second SCI2 message indicates one or more of the second destination ID or second HARQ information associated with the second TB.

In a fourth aspect, in combination with one or more of the first aspect through the third aspect, the processing system is further configured to transmit, in accordance with a two-stage SCI format, a stage-one sidelink control information (SCI1) message associated with the single PSSCH transmission and to transmit, in accordance with the two-stage SCI format, a stage-two sidelink control information (SCI2) message associated with the single PSSCH transmission. The SCI2 message indicates scheduling of multiple TBs of the same PSSCH transmission, the multiple TBs including the first TB and the second TB.

In a fifth aspect, in combination with one or more of the first aspect through the fourth aspect, the SCI2 message has a format type that is associated with scheduling of the multiple TBs, and the SCI1 message indicates the format type.

In a sixth aspect, in combination with one or more of the first aspect through the fifth aspect, the SCI2 message includes information identifying the multiple TBs. The information includes the first destination ID and the second destination ID. The SCI1 message indicates a quantity of the multiple TBs, and the SCI2 message includes the quantity of destination IDs. The destination IDs include the first destination ID and the second destination ID.

In a seventh aspect, in combination with one or more of the first aspect through the sixth aspect, the processing system is further configured to transmit a stage-one sidelink control information (SCI1) message in accordance with a two-stage SCI messaging scheme. The SCI1 message indicates a resource allocation associated with at least one of the first TB and the second TB.

In an eighth aspect, in combination with one or more of the first aspect through the seventh aspect, the processing system is further configured to transmit a stage-one sidelink control information (SCI1) message in accordance with a two-stage SCI format. The SCI1 message indicates a resource allocation associated with the same PSSCH transmission. The processing system is further configured to transmit one or more stage-two sidelink control information (SCI2) messages in accordance with the two-stage SCI format. The one or more SCI2 messages indicate a first resource allocation associated with the first TB and further indicate a second resource allocation associated with the second TB.

In a ninth aspect, in combination with one or more of the first aspect through the eighth aspect, the processing system is further configured to transmit, in accordance with a two-stage SCI format, a first stage-two sidelink control information (SCI2) message associated with the same PSSCH transmission. The first SCI2 message is associated with a first subset of resources of a set of resources. The processing system is further configured to transmit, in accordance with the two-stage SCI format, a second SCI2 message associated with the same PSSCH transmission. The second SCI2 message is associated with a second subset of resources of the set of resources. The second subset is selected for the second SCI2 message following selection of the first subset for the first SCI2 message.

In a tenth aspect, in combination with one or more of the first aspect through the ninth aspect, the processing system is further configured to transmit, in accordance with a two-stage SCI format, a first stage-two sidelink control information (SCI2) message associated with the same PSSCH transmission. The first SCI2 message is associated with a first subchannel that is associated with the first TB. The processing system is further configured to transmit, in accordance with the two-stage SCI format, a second SCI2 message associated with the same PSSCH transmission. The second SCI2 message is associated with a second subchannel that is associated with the second TB.

In an eleventh aspect, a method of wireless communication by a user equipment (UE) includes performing a multi-transport block (TB) resource mapping operation that maps, to a set of physical resource blocks (PRBs), first bits of a first TB associated with a first destination identifier (ID) and second bits of a second TB associated with a second destination ID. The method further includes transmitting a single physical sidelink shared channel (PSSCH) transmission via the set of PRBs. The single PSSCH transmission includes the first TB addressed to the first destination ID and the second TB addressed to the second destination ID.

In a twelfth aspect, in combination with the eleventh aspect, performing the multi-TB resource mapping operation includes assigning the first bits and the second bits to a set of virtual resource blocks (VRBs) associated with the set of PRBs.

In a thirteenth aspect, in combination with one or more of the eleventh aspect through the twelfth aspect, assigning the first bits and the second bits includes separately partitioning, on a per-VRB basis, the first bits to one or more first VRBs of the set of VRBs and the second bits to one or more second VRBs of the set of VRBs.

In a fourteenth aspect, in combination with one or more of the eleventh aspect through the thirteenth aspect, assigning the first bits and the second bits includes separately partitioning, on a per-VRB-bundle basis, the first bits to one or more first VRB bundles included in the set of VRBs and the second bits to one or more second VRB bundles included in the set of VRBs.

In a fifteenth aspect, in combination with one or more of the eleventh aspect through the fourteenth aspect, assigning the first bits and the second bits includes separately partitioning, on a per-subchannel basis, the first bits to one or more first VRBs of the set of VRBs and the second bits to one or more second VRBs of the set of VRBs. The one or more first VRBs are associated with a first subchannel used to transmit the first TB, and the one or more second VRBs are associated with a second subchannel used to transmit the second TB.

In a sixteenth aspect, a non-transitory computer-readable medium stores instructions executable by one or more processors of a user equipment (UE) to initiate, perform, or control operations. The operations include performing a multi-transport block (TB) resource mapping operation that maps, to a set of physical resource blocks (PRBs), first bits of a first TB associated with a first destination identifier (ID) and second bits of a second TB associated with a second destination ID. The operations further include transmitting a single physical sidelink shared channel (PSSCH) transmission via the set of PRBs. The single PSSCH transmission includes the first TB addressed to the first destination ID and the second TB addressed to the second destination ID.

In a seventeenth aspect, in combination with the sixteenth aspect, both the first destination ID and the second destination ID are associated with a same second UE, the first destination ID is associated with a first application executing in the second UE, and the second destination ID is associated with a second application executing in the second UE different than the first application.

In an eighteenth aspect, in combination with one or more of the sixteenth aspect through the seventeenth aspect, the first destination ID is associated with a second UE and the second destination ID is associated with a third UE different than the second UE.

In a nineteenth aspect, in combination with one or more of the sixteenth aspect through the eighteenth aspect, the first destination ID includes at least a portion of a first layer-2 destination ID, and the second destination ID includes at least a portion of a second layer-2 destination ID.

In a twentieth aspect, in combination with one or more of the sixteenth aspect through the nineteenth aspect, the first destination ID includes at least a portion of a first application layer ID, and the second destination ID includes at least a portion of a second application layer ID.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes . 1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a processing system including one or more processors and one or more memories coupled to the one or more processors, the processing system configured to:
perform a multi-transport block (TB) resource mapping operation that maps, to a set of physical resource blocks (PRBs), first bits of a first TB associated with a first destination identifier (ID) and second bits of a second TB associated with a second destination ID; and
transmit a single physical sidelink shared channel (PSSCH) transmission via the set of PRBs that includes the first TB addressed to the first destination ID and the second TB addressed to the second destination ID.

2. The apparatus of claim 1, wherein the processing system is further configured to transmit, in accordance with a two-stage SCI format, a stage-one sidelink control information (SCI1) message associated with the single PSSCH transmission, wherein the SCI1 message indicates one or more of a quantity of stage-two sidelink control information (SCI2) messages associated with the single PSSCH transmission that are to follow the SCI1 message, respective modulation and coding schemes (MCSs) associated with the first TB and the second TB, or respective resource allocations for the first TB and the second TB.

3. The apparatus of claim 2, wherein the processing system is further configured to:
transmit, in accordance with the two-stage SCI format, a first SCI2 message of the SCI2 messages, the first SCI2 message indicating one or more of the first destination ID or first hybrid automatic repeat request (HARQ) information associated with the first TB; and
transmit, in accordance with the two-stage SCI format, a second SCI2 message of the SCI2 messages, the second SCI2 message indicating one or more of the second destination ID or second HARQ information associated with the second TB.

4. The apparatus of claim 1, wherein the processing system is further configured to:
transmit, in accordance with a two-stage SCI format, a stage-one sidelink control information (SCI1) message associated with the single PSSCH transmission; and
transmit, in accordance with the two-stage SCI format, a stage-two sidelink control information (SCI2) message associated with the single PSSCH transmission,
wherein the SCI2 message indicates scheduling of multiple TBs of the same PSSCH transmission, the multiple TBs including the first TB and the second TB.

5. The apparatus of claim 4, wherein the SCI2 message has a format type that is associated with scheduling of the multiple TBs, and wherein the SCI1 message indicates the format type.

6. The apparatus of claim 4, wherein the SCI2 message includes information identifying the multiple TBs, wherein the information includes the first destination ID and the second destination ID, wherein the SCI1 message indicates a quantity of the multiple TBs, and wherein the SCI2 message includes the quantity of destination IDs, the destination IDs including the first destination ID and the second destination ID.

7. The apparatus of claim 1, wherein the processing system is further configured to transmit a stage-one sidelink control information (SCI1) message in accordance with a two-stage SCI messaging scheme, the SCI1 message indicating a resource allocation associated with at least one of the first TB and the second TB.

8. The apparatus of claim 1, wherein the processing system is further configured to:
transmit a stage-one sidelink control information (SCI1) message in accordance with a two-stage SCI format, wherein the SCI1 message indicates a resource allocation associated with the same PSSCH transmission; and
transmit one or more stage-two sidelink control information (SCI2) messages in accordance with the two-stage SCI format, wherein the one or more SCI2 messages indicate a first resource allocation associated with the first TB and further indicate a second resource allocation associated with the second TB.

9. The apparatus of claim 1, wherein the processing system is further configured to:
transmit, in accordance with a two-stage SCI format, a first stage-two sidelink control information (SCI2) message associated with the same PSSCH transmission, the first SCI2 message associated with a first subset of resources of a set of resources; and
transmit, in accordance with the two-stage SCI format, a second SCI2 message associated with the same PSSCH transmission, the second SCI2 message associated with a second subset of resources of the set of resources,
wherein the second subset is selected for the second SCI2 message following selection of the first subset for the first SCI2 message.

10. The apparatus of claim 1, wherein the processing system is further configured to:
transmit, in accordance with a two-stage SCI format, a first stage-two sidelink control information (SCI2) message associated with the same PSSCH transmission, the first SCI2 message associated with a first subchannel that is associated with the first TB; and
transmit, in accordance with the two-stage SCI format, a second SCI2 message associated with the same PSSCH transmission, the second SCI2 message associated with a second subchannel that is associated with the second TB.

11. A method of wireless communication by a user equipment (UE), the method comprising:
performing a multi-transport block (TB) resource mapping operation that maps, to a set of physical resource blocks (PRBs), first bits of a first TB associated with a first destination identifier (ID) and second bits of a second TB associated with a second destination ID; and
transmitting a single physical sidelink shared channel (PSSCH) transmission via the set of PRBs that includes the first TB addressed to the first destination ID and the second TB addressed to the second destination ID.

12. The method of claim 11, wherein performing the multi-TB resource mapping operation includes assigning the first bits and the second bits to a set of virtual resource blocks (VRBs) associated with the set of PRBs.

13. The method of claim 12, wherein assigning the first bits and the second bits includes separately partitioning, on a per-VRB basis, the first bits to one or more first VRBs of the set of VRBs and the second bits to one or more second VRBs of the set of VRBs.

14. The method of claim 12, wherein assigning the first bits and the second bits includes separately partitioning, on a per-VRB-bundle basis, the first bits to one or more first VRB bundles included in the set of VRBs and the second bits to one or more second VRB bundles included in the set of VRBs.

15. The method of claim 12, wherein assigning the first bits and the second bits includes separately partitioning, on a per-subchannel basis, the first bits to one or more first VRBs of the set of VRBs and the second bits to one or more second VRBs of the set of VRBs, wherein the one or more first VRBs are associated with a first subchannel used to transmit the first TB, and wherein the one or more second VRBs are associated with a second subchannel used to transmit the second TB.

16. A non-transitory computer-readable medium storing instructions executable by one or more processors of a user equipment (UE) to initiate, perform, or control operations, the operations comprising:
performing a multi-transport block (TB) resource mapping operation that maps, to a set of physical resource blocks (PRBs), first bits of a first TB associated with a first destination identifier (ID) and second bits of a second TB associated with a second destination ID; and
transmitting a single physical sidelink shared channel (PSSCH) transmission via the set of PRBs that includes the first TB addressed to the first destination ID and the second TB addressed to the second destination ID.

17. The non-transitory computer-readable medium of claim 16, wherein both the first destination ID and the second destination ID are associated with a same second UE, wherein the first destination ID is associated with a first application executing in the second UE, and wherein the second destination ID is associated with a second application executing in the second UE different than the first application.

18. The non-transitory computer-readable medium of claim 16, wherein the first destination ID is associated with a second UE and the second destination ID is associated with a third UE different than the second UE.

19. The non-transitory computer-readable medium of claim 16, wherein the first destination ID includes at least a portion of a first layer-2 destination ID, and wherein the second destination ID includes at least a portion of a second layer-2 destination ID.

20. The non-transitory computer-readable medium of claim 16, wherein the first destination ID includes at least a portion of a first application layer ID, and wherein the second destination ID includes at least a portion of a second application layer ID.
